(19) United States
(12) Patent Application Publication
(10) Pub. No.: US 2010/0094721 A1
(43) Pub. Date: Apr. 15, 2010

(54) METHOD OF DIRECTLY TRADING PRODUCTS USING INTERNET-BASED COMMUNITY

(75) Inventors: Byoung Chul Kim, Jeollabuk-do (KR); Shang Yeop Han, Jeollabuk-do (KR)

Correspondence Address: Jae Y. Park, Kile, Goekjian, Reed & McManus, PLLC, 1200 New Hampshire Ave. NW, Suite 570, Washington, DC, 20036, US

(73) Assignee: NYTEL CO., LTD., Jeonju-si (KR)

(21) Appl. No.: 12/542,406

(22) Filed: Aug. 17, 2009

(30) Foreign Application Priority Data
Oct. 14, 2008 (KR) 10-2008-0100684

(51) Int. Cl. G06Q 30/00

(52) U.S. Cl. 705/26

(57) ABSTRACT

The present invention relates to a method of directly trading products using an Internet-based community, in which each member registers an area, associated with both products that may be directly traded by the member and the member's traffic line, as a possible direct trading area. In the method, a management server receives a possible direct trading area from a terminal of a relevant member and stores information about the possible direct trading area in a database. The management server transmits information about a neighbor member who registered an identical possible direct trading area to the terminal of the relevant member. When a request to view information about a product registered by the neighbor member is received from the terminal of the relevant member, the management server extracts information about the product from the database and transmits the extracted product information to the terminal of the relevant member.

### BACKGROUND OF THE INVENTION

1. Field of the Invention

The present invention relates to a method of directly trading products using an Internet-based community, in which each member registers an area, associated with both products that may be directly traded by the member and the member's traffic line, as a possible direct trading area, thus inviting each member to conduct trading in a desired area.

2. Description of the Related Art

Currently, most people determine whether to purchase a product after searching over the Internet for information about the details and price of the product and reading follow-up posts about the use of the product even when desiring to purchase just a small product. Further, as the period for change in the design of products and the replacement of products has become shortened, the trading of used products has been activated.

A conventional online trading website for used products enables the used products to be traded in each online community and provides a simple notice board-type User Interface (UI). However, although a large number of users visit and use the website, instances of fraud frequently occur when used products are traded.

In this situation, the need for a convenient UI and a reliable website in which used products can be trustworthily and reliably traded has gradually increased.

### SUMMARY OF THE INVENTION

Accordingly, the present invention has been made keeping in mind the above problems occurring in the conventional online used product trading websites, and an object of the present invention is to provide a method of directly trading products using an Internet-based community, in which each member can register an area, associated with both products that may be directly traded and the member's traffic line, as a possible direct trading area, so that each member is invited to easily conduct trading in a desired direct trading area, thus enabling products to be reliably traded.

In order to accomplish the above object, the present invention provides a method of directly trading products using an Internet-based community, comprising a) a management server receiving a possible direct trading area from a terminal of a relevant member and storing information about the possible direct trading area in a database; b) the management server transmitting information about a neighbor member who registered a possible direct trading area identical to that of the relevant member to the terminal of the relevant member; and c) when a request to view information about a product registered by the neighbor member is received from the terminal of the relevant member, the management server extracting information about the product from the database and transmitting the extracted product information to the terminal of the relevant member.

Preferably, the possible direct trading area comprises one or more of predetermined areas in which products can be directly traded between members, for example, a specific building, an apartment complex, a bus stop, a subway station, a school and a company.

Preferably, the method further comprises, after b), when a request for registration of a specific neighbor member, from among neighbor members, as a neighbor is received from the terminal of the relevant member, the management server storing the specific neighbor member as ‘my inactive neighbor’ in the database; and when acceptance for the request of the neighbor registration is received from a terminal of the specific neighbor member, the management server storing the relevant member and the specific neighbor member as ‘my mutually active neighbors’.

Preferably, the method further comprises, after c), when a request for purchase of the product of the neighbor member is received from the terminal of the relevant member, the management server storing information about the product purchase request in the database; transmitting the information about the product purchase request when the terminal of the neighbor member accesses the management server; when acceptance information, such as an intention to accept the product purchase request and a schedule for direct trading of the product, is received from the terminal of the neighbor member, the management server storing the acceptance information in the database; and transmitting the acceptance information when the terminal of the member accesses the management server.

Preferably, the method further comprises when completion of direct trading of the product with the neighbor member is registered by the terminal of the relevant member, the management server requesting the relevant member to evaluate determination items for reliability such as determination of whether the product information of the neighbor member matches a directly traded product, whether an appointed schedule for direct trading was adhered to, and other reliability determination items; and the management server evaluating reliability of the neighbor member based on results of the evaluation of the reliability determination items on the neighbor member, and storing results of evaluation of the reliability in the database.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an example of a system for implementing a method of directly trading products using an Internet-based community according to the present invention;

FIG. 2 is a block diagram schematically showing the construction of a management server;

FIG. 3 is a flowchart schematically showing a procedure for registering and storing ‘my inactive neighbor’ and ‘my active neighbor’;

FIGS. 4 and 5 are flowcharts schematically showing a procedure for outputting neighbor member information and product information based on the registration of a possible direct trading area;

FIG. 6 is a flowchart schematically showing a procedure for requesting the direct trading of a product and evaluating satisfaction level; and

FIG. 7 is a flowchart schematically showing a procedure for evaluating reliability.

### DESCRIPTION OF THE PREFERRED EMBODIMENTS

Hereinafter, embodiments of a method of directly trading products using an Internet-based community according to the present invention will be described in detail with reference to the attached drawings. The scope of the present invention is not limited to the following embodiments.

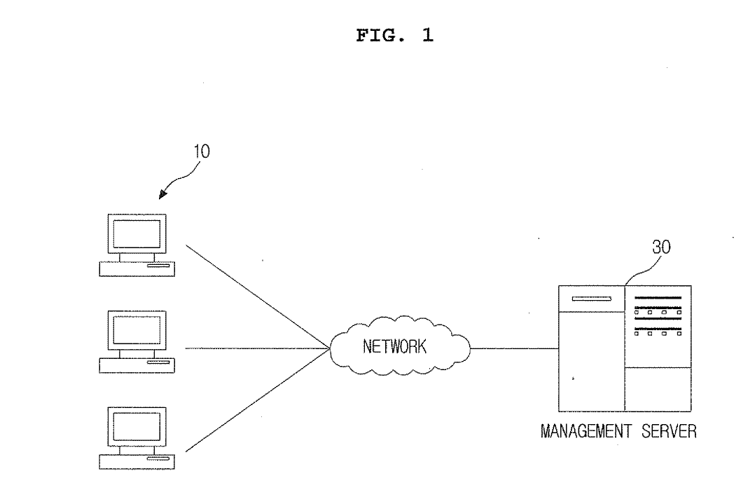

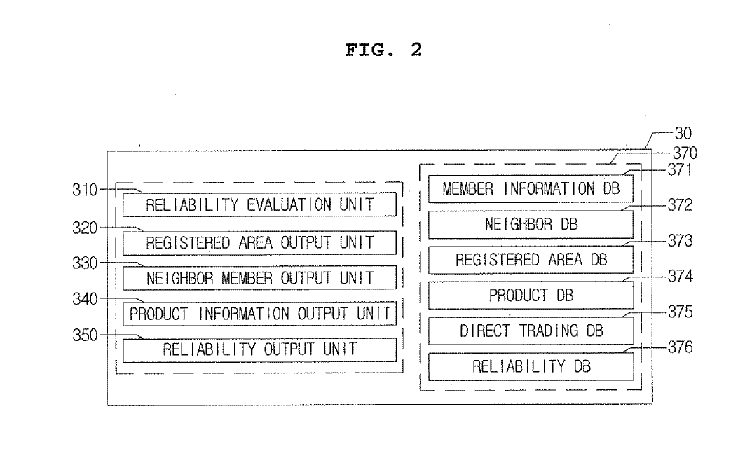

FIG. 1 is a diagram schematically showing an example of a system for implementing a method of directly trading products using an Internet-based community according to the present invention, and FIG. 2 is a block diagram schematically showing the construction of a management server 30.

The method of directly trading products using an Internet-based community according to the present invention is implemented using the management server 30 for conducting the direct trading of products over the Internet, and terminals 10 of a plurality of members connected to the management server 30 over the network (Internet) and configured to register products for direct trading, possible direct trading areas, etc., as shown in FIG. 1. The member terminals 10 refer to a Personal Computer (PC), a mobile phone, a smart phone, an Internet Protocol (IP) TV, etc.

The management server 30 includes a database (DB) 370 for storing information about members, information about possible direct trading areas and times, information about products, information about product purchase request and acceptance, information about each member's satisfaction level, etc., a reliability evaluation unit 310, a registered area output unit 320, a neighbor member output unit 330, a product information output unit 340, and a reliability output unit 350.

The DB 370 includes a member information DB 371, a neighbor DB 372, a registered area DB 373, a product DB 374, a direct trading DB 375 and a reliability DB 376.

The member information DB 371 stores basic information about names, addresses and contact addresses.

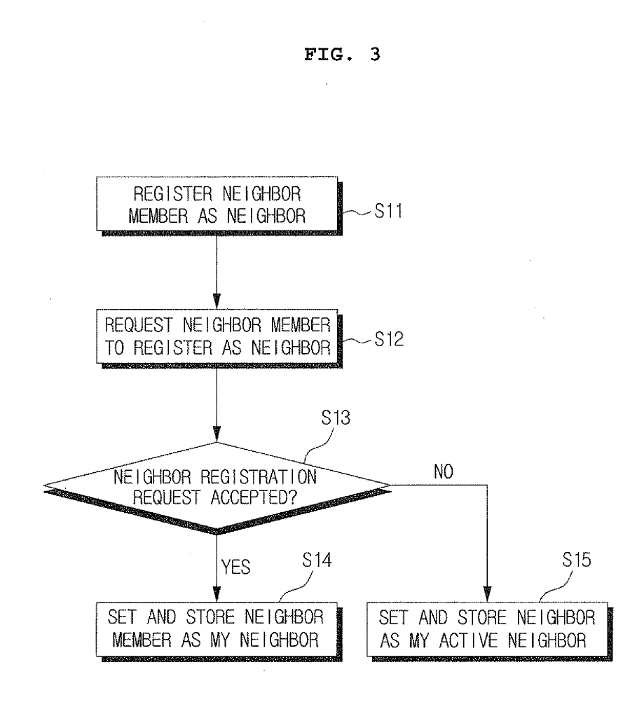

FIG. 3 is a flowchart schematically showing a procedure for registering and storing ‘my active neighbor’ and ‘my inactive neighbor’.

When each member registers a specific neighbor member among neighbor members as his or her neighbor, as shown in FIG. 3, the neighbor DB 372 stores the specific neighbor member as ‘my inactive neighbor’. Further, when the member and the specific neighbor member mutually register each other as their neighbors, the two members are respectively registered and stored by opposite members as ‘my neighbors’. In detail, when any one member registers a specific neighbor member among neighbor members as his or her neighbor, the member requests the specific neighbor member to register the member as his or her neighbor. When the specific neighbor member accepts the request for the neighbor registration, the requesting member and the specific neighbor member set and store opposite members as ‘my mutually active neighbors’, whereas when the specific neighbor member does not accept the request, the requesting member sets and stores the specific neighbor member as ‘my inactive neighbor’ at steps S11 to S15.

In the case of friends, that is, neighbor members for which reliability has been obtained, opposite members register each other as ‘my mutually active neighbors’, thus enabling products to be directly traded more safely and more reliably.

The registered area DB 373 stores information about areas in which products can be directly traded, possible direct trading times corresponding to the areas, etc. The term ‘possible direct trading areas’ includes one or more of predetermined areas in which products can be directly traded between members, for example, a specific building, an apartment complex, a bus stop, a subway station, a school and a company. Each member may designate and register one or more areas associated with his or her traffic line.

The product DB 374 stores the names of products for direct trading, the date of manufacture of the products, the date of purchase of the products, the condition of the products, selling prices, product images, determination of whether the respective products are public or private, possible direct trading areas of the products, and other types of product information. Here, the term ‘products’ generally means used products, but they are not limited to such used products. In the product DB 374, each registered product may be registered while ‘public or private’, ‘my neighbors only’, etc. are designated for the product. Therefore, when an intention to directly trade a product has not been fixed yet, the product may be registered as a ‘private’ entry. Further, when a member desires to directly trade a product with ‘my neighbors’ for which reliability has been obtained, the member may register a relevant product as a ‘my neighbors only’ entry so that the product is visible only to ‘my neighbors’. Further, it is possible to select a relevant area from among registered possible direct trading areas and to register corresponding products in the selected area depending on the volume, weight and type of registered products.

Further, the direct trading DB 375 stores information related to direct trading, for example, purchase request information such as members who requested the purchase of products stored in the product DB 374 and the date and time of the purchase request, acceptance information such as the date and time of acceptance for the purchase request, information about a schedule for direct trading, and information about the completion of direct trading. Further, in the direct trading DB, the number of times each member conducted direct trading may be registered and stored, which may be utilized as an index of reliability when other neighbor members conduct direct trading and request direct trading.

The reliability DB 376 stores the results of the evaluation of various reliability determination items, such as information about the degree of matching between product information stored in the product DB 374 and an actually directly traded product after direct trading has been conducted, the degree of adherence to an appointed schedule for direct trading, and the degree of kindness, and the results of evaluation of reliability.

Further, the reliability evaluation unit 310 evaluates reliability according to the score or rank on the basis of the results of the evaluation of the reliability determination items stored in the reliability DB 376, and stores the results of evaluation of reliability in the reliability DB 376.

The registered area output unit 320 outputs information about the possible direct trading area of a relevant member stored in the registered area DB 373 over the web when the relevant member accesses the management server 30 through his or her member terminal. The neighbor member output unit 330 outputs information about other members who registered the same possible direct trading area as the relevant member, that is, information about neighbor members, to the terminal of the relevant member over the web. Accordingly, each member can easily understand neighbor members who registered the same area as the possible direct trading area registered by the member, thus promoting the activation of direct trading.

The product information output unit 340 outputs information about the product of a neighbor member stored in the product DB 374 over the web when the relevant member requests the viewing of the product, registered by the neighbor member, by moving a mouse over or clicking the mouse on information about the neighbor member displayed over the web through the neighbor member output unit 330.

Further, the reliability output unit 350 outputs the results of the evaluation of the reliability of respective neighbor members, conducted by the reliability evaluation unit 310, to the terminal of the relevant member over the web. The reliability output unit 350 may output the results of the evaluation of the reliability of the neighbor members together with the neighbor member information and the product information. In this way, the reliability of the neighbor members is evaluated and the results of the evaluation are displayed by the reliability output unit 350, thus allowing the respective members to invite their neighbor members to accumulate reliability, and enabling the results of reliability evaluation to be used as an index of determination when each member requests the direct trading of products from the neighbor members or accepts a request received from the neighbor members.

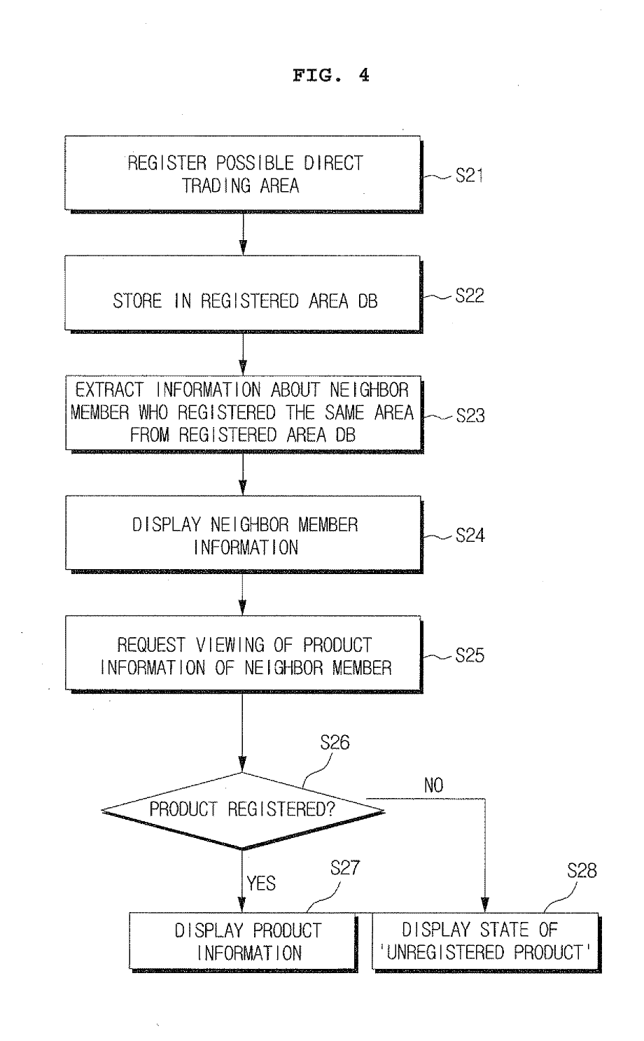

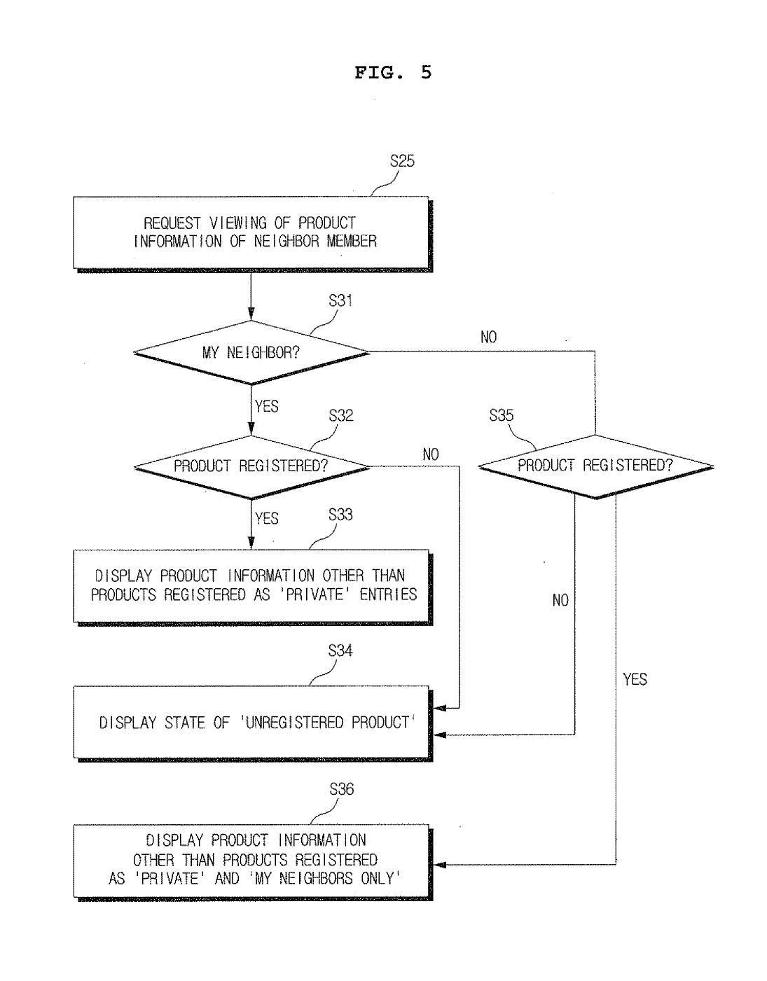

FIGS. 4 and 5 are flowcharts schematically showing a procedure for outputting neighbor member information and product information based on the registration of possible direct trading areas.

When a relevant member registers a possible direct trading area in the management server 30 through his or her terminal at step S21, the possible direct trading area is stored in the registered area DB 373 of the management server 30 at step S22, and the possible direct trading area is output to the terminal of the relevant member over the web. In this case, information about a neighbor member who registered the same possible direct trading area as the relevant member is extracted from the registered area DB 373 and is displayed over the web at steps S23 and S24.

Further, in the case where a request to view product information of the neighbor member is received from the relevant member through the manipulation of the terminal of the relevant member such as by moving a mouse over or clicking the mouse on the product information, when the product information of the neighbor member is stored in the product DB 374, the product information of the neighbor member is extracted from the product DB 374 and displayed over the web at steps S25 and S26. In contrast, when the product information of the neighbor member is not stored in the product DB 374, a state of ‘unregistered product’ is displayed over the web at step S27.

In this case, in the case where the product information of the neighbor member is registered in the product DB 374, but all or some products thereof are registered as ‘public’ or ‘my neighbors only’ entries, if a request to view the product information of the neighbor member is received from the terminal of the relevant member, whether the relevant member is registered as ‘my neighbor’ of the neighbor member is determined at steps S25 and S31. If it is determined that the relevant member is registered as ‘my neighbor’ of the neighbor member, when the product is registered in the product DB 374, information about products other than products designated as ‘private’ entries is displayed, whereas when all products are registered as ‘private’ entries or when no products are registered, a state of ‘unregistered product’ is displayed at steps S32 to S34.

Further, if it is determined that the relevant member is not set as ‘my neighbor’ of the neighbor member, when the product is registered in the product DB 374, information about products other than products registered as ‘private’ or ‘my neighbors only’ entries is displayed, whereas when all products are registered as ‘private’ or ‘my neighbors only’ entries or when no products are registered, a state of ‘unregistered product’ is displayed at steps S35, S34 and S36.

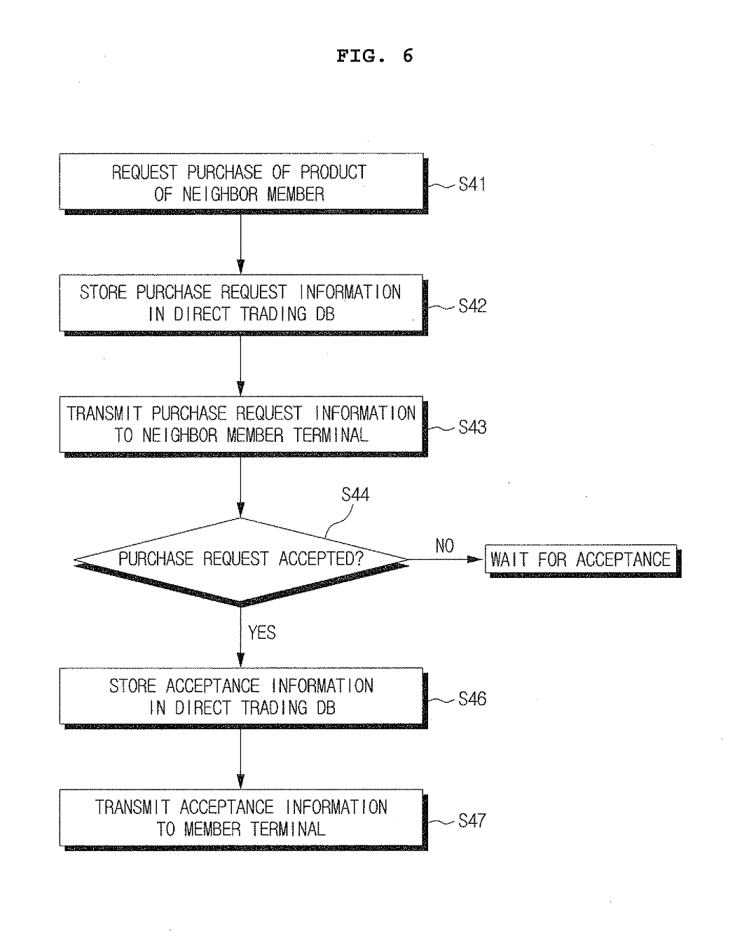

FIG. 6 is a flowchart schematically showing a procedure for requesting the direct trading of products and evaluating satisfaction level.

When a relevant member views the product information of a neighbor member through his or her terminal and makes a request for the purchase of the product of the neighbor member, the management server 30 stores information about the product purchase request in the direct trading DB 375 at steps S41 and S42. Further, when the terminal of the neighbor member accesses the management server 30, the information about the product purchase request stored in the direct trading DB 375 is transmitted to the terminal of the neighbor member and is output over the web at step S43. When acceptance information, such as an intention to accept the member's product purchase request and a schedule for direct trading of the product, is received from the terminal of the neighbor member, this acceptance information is stored in the direct trading DB 375 of the management server 30 at steps S44 and S46. When the terminal of the relevant member accesses the management server 30, the management server 30 transmits the direct trading information to the terminal and outputs the direct trading information over the web at step S47.

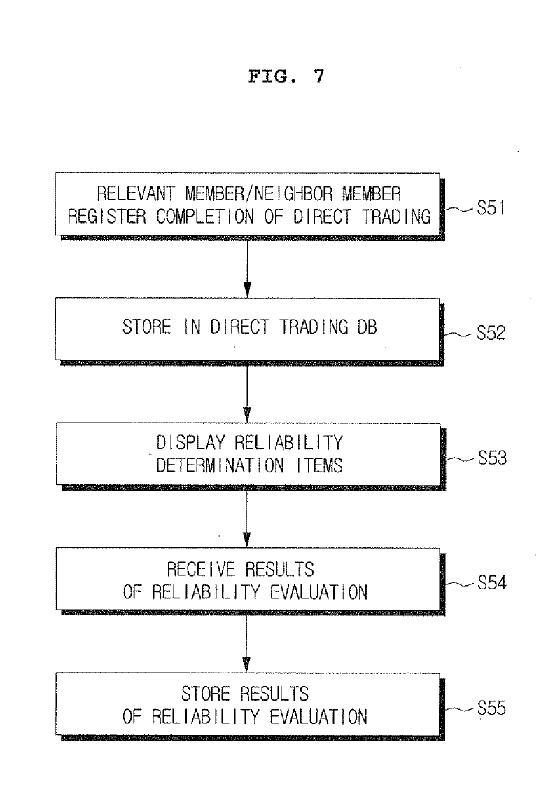

FIG. 7 is a flowchart schematically showing a procedure for evaluating reliability.

When the direct trading of the product between the relevant member and the neighbor member has been completed, or when the completion of the direct trading of the product is registered by the terminal of the relevant member or the neighbor member, the management server 30 displays evaluation items for reliability, such as the degree of matching between the product information stored in the product DB 374 and an actually directly traded product, the degree of adherence to an appointed schedule for direct trading and the degree of kindness, on the terminal of the relevant member or the neighbor member over the web at steps S51 to S53. When the results of the evaluation of reliability determination items are received from the terminal of the relevant member or the neighbor member, the results of the evaluation of the reliability determination items are stored in the reliability DB 376 at step S54. Further, the reliability evaluation unit 310 evaluates the reliability of the relevant member and the neighbor member on the basis of accumulated reliability information and newly evaluated reliability information, and stores the results of the evaluation in the reliability DB 376.

As described above, a method of directly trading products using an Internet-based community according to the present invention is advantageous in that each member can register an area, associated with both products that may be directly traded and the member's traffic line, as a possible direct trading area, so that each member is invited to easily conduct trading in a desired direct trading area, thus enabling products to be reliably traded.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of directly trading products using an Internet-based community, comprising:
a) a management server receiving a possible direct trading area from a terminal of a relevant member and storing information about the possible direct trading area in a database;
b) the management server transmitting information about a neighbor member who registered a possible direct trading area identical to that of the relevant member to the terminal of the relevant member; and
c) when a request to view information about a product registered by the neighbor member is received from the terminal of the relevant member, the management server extracting information about the product from the database and transmitting the extracted product information to the terminal of the relevant member.

2. The method according to claim 1, wherein the possible direct trading area comprises one or more of predetermined areas in which products can be directly traded between members, for example, a specific building, an apartment complex, a bus stop, a subway station, a school and a company.

3. The method according to claim 1, further comprising, after b):
when a request for registration of a specific neighbor member, from among neighbor members, as a neighbor is received from the terminal of the relevant member, the management server storing the specific neighbor member as ‘my inactive neighbor’ in the database; and
when acceptance for the request of the neighbor registration is received from a terminal of the specific neighbor member, the management server storing the relevant member and the specific neighbor member as ‘my mutually active neighbors’.

4. The method according to claim 1, further comprising, after c):
when a request for purchase of the product of the neighbor member is received from the terminal of the relevant member, the management server storing information about the product purchase request in the database;
transmitting the information about the product purchase request when the terminal of the neighbor member accesses the management server;
when acceptance information, such as an intention to accept the product purchase request and a schedule for direct trading of the product, is received from the terminal of the neighbor member, the management server storing the acceptance information in the database; and
transmitting the acceptance information when the terminal of the member accesses the management server.

5. The method according to claim 4, further comprising:
when completion of direct trading of the product with the neighbor member is registered by the terminal of the relevant member, the management server requesting the relevant member to evaluate determination items for reliability such as determination of whether the product information of the neighbor member matches a directly traded product, whether an appointed schedule for direct trading was adhered to, and other reliability determination items; and
the management server evaluating reliability of the neighbor member based on results of the evaluation of the reliability determination items on the neighbor member, and storing results of evaluation of the reliability in the database.
